(19) United States
(12) Patent Application Publication
(10) Pub. No.: US 2013/0187348 A1
(43) Pub. Date: Jul. 25, 2013

(54) Sealing Tape for Sealing a Joint

(71) Applicant: ISO-Chemie GmbH, Aalen (DE)

(72) Inventor: Martin Deiss, Abtsgmuend (DE)

(73) Assignee: ISO-CHEMIE GMBH, Aalen (DE)

(21) Appl. No.: 13/746,553

(22) Filed: Jan. 22, 2013

(30) Foreign Application Priority Data
Jan. 24, 2012 (EP) 12152236.1

(51) Int. Cl. F16J 15/02; B31F 7/00

(52) U.S. Cl. CPC F16J 15/02; B31F 7/00
USPC 277/647; 493/356

(57) ABSTRACT

The sealing tape for sealing a joint has a first foam strip and a second foam strip of a flexible foam capable of recovery after compression, the first and second foam strips arranged next to each other in a functional direction of the sealing tape. A sheet-type strip serving to reduce a permeability of the sealing tape to diffusion of water vapor in the functional direction is arranged between the first foam strip and the second foam strip and has a section arranged in the shape of a U or V, wherein a first limb and a second limb of this section extend toward the top of the sealing tape.

### CROSS REFERENCE TO RELATED APPLICATION

This application claims priority based on European patent application EP 12 152 236.1 filed Jan. 24, 2012.

### FIELD OF THE INVENTION

The invention pertains to a sealing tape for sealing a joint and to a suitable production method

### BACKGROUND OF THE INVENTION

Sealing tapes of soft, flexible foam material are used generally in the construction industry to seal joints against drafts and driving rain. In professional building construction, sealing tapes of soft, flexible foam are used between window and door frames and a masonry wall. Such sealing tapes can be up to a few centimeters thick and are usually provided with a pressure-sensitive adhesive layer on the bottom, by which they can be adhered to the profiled framing elements of windows and doors. To facilitate the installation of the structural component provided with the sealing tape at the building site, sealing tapes of this type, which are delivered in a compressed state in rolls, are often impregnated with a material which delays the recovery of the foam from the compressed state to the expanded state.

To prevent the diffusion of water vapor and to improve the sealing effect against air, sealing tapes of the type indicated above must be provided with a vapor barrier. A sealing tape of open-pore material in the form of a rolled-up disk for sealing joints or gaps against drafts and driving rain is known from DE 196 41 415. At least one barrier layer is arranged inside the sealing tape to create a configuration in which the barrier layer and the adjacent open-pore areas form a row in the axial direction. The barrier layer therefore extends in the radial direction of the sealing tape roll, and the barrier can thus, after the sealing tape has been unwound from the roll, serve as a vapor diffusion barrier in the functional direction of the sealing tape, i.e., the direction which extends from the one lateral surface of the sealing tape to the other lateral surface of the sealing tape.

To produce a sealing tape of the latter type, barrier layers with a large surface area are formed by laminating and/or adhesively bonding sheets or webs of raw open-pore foam material in layered fashion to create laminated blocks. The laminated blocks are then cut at a right angle to the large barrier layers of lamination material and/or adhesive to form plates with barrier layers, so that, after the cutting operation, the barrier layers are parallel to one edge of the plate and extend vertically through the plate. A plate of this type is then wound up under compression into a roll, so that, on the circumference of the roll, the barrier layers and the open-pore material alternate with each other in the axial direction. Finally, the roll is cut into disks between the individual barrier layers. This procedure is relatively complicated and requires a high degree of dimensional stability of the foam material during processing and when it is being wound up into a roll, because otherwise, when the roll is cut into disks, there is the danger of damage to the barrier layers.

### SUMMARY OF THE INVENTION

It is an object of the present invention to provide a sealing tape for sealing a joint which not only offers a low degree of permeability to air and a reduced degree of permeability to the diffusion of water vapor but is also especially easy and cheap to produce.

According to an aspect of the invention, the sealing tape for sealing a joint comprises

a top, a bottom, and two longitudinal sides, wherein a direction parallel to the top and bottom and transverse to the longitudinal sides defines a functional direction of the sealing tape;

at least one first foam strip and one second foam strip of a flexible foam capable of recovery after compression, the first and second foam strips arranged next to each other in the functional direction; and

a sheet-type strip serving to reduce a permeability of the sealing tape to diffusion of water vapor in the functional direction, the sheet-type strip arranged between the first foam strip and the second foam strip and comprising a section arranged substantially in the shape of a U or V, wherein a first limb and a second limb of the section of the sheet-type strip arranged substantially in the shape of a U or V extend toward the top of the sealing tape.

With this design, the sealing function is improved over that of conventional flexible foam tapes, wherein the task of equipping the flexible foam with the sheet-type strip can be easily automated.

The first limb of the substantially U-shaped or V-shaped section of the sheet-type strip is preferably bonded to at least certain areas of the side of the first foam strip facing the second foam strip, and the second limb of the substantially U-shaped or V-shaped section of the sheet-type strip is bonded to at least certain areas of the side of the second foam strip facing the first foam strip. As a result, the sheet-type strip is held securely in place, and the two foam strips are permanently connected to each other at least by the sheet-type strip, independently of any other design measure which may be provided.

It is especially preferred for the sheet-type strip to be laminated or adhesively bonded to the two foam strips.

As part of an especially simple production variant, the crest or apex of the substantially U-shaped or V-shaped section of the sheet-type strip is arranged inside the sealing tape.

The limbs of the substantially U-shaped or V-shaped section of the sheet-type strip preferably enclose an angle in the range of between 10° and 0°, more preferably an angle in the range of between 3° and 0°, when the sealing tape is in the fully expanded state. When the angle in question is 0°, the two limbs of the sheet-type strip rest directly against each other, so that it is impossible for any air to be trapped inside the sealing tape.

Accordingly, the limbs of the substantially U-shaped or V-shaped section of the sheet-type strip are substantially perpendicular to the functional direction and parallel to the longitudinal sides of the sealing tape. In this way, optimal use of the barrier properties of the sheet-type strip in the functional direction is guaranteed.

The crest or apex of the substantially U-shaped or V-shaped section of the sheet-type strip is preferably arranged within an area extending over a range of between 1 and 40%, more preferably over a range of between 5 and 20%, of the height of the sealing tape when the sealing tape is in the fully expanded state. This ensures that the barrier function of the sheet-type strip acts over almost the entire height of the sealing tape and simultaneously that enough space remains for a direct connection between the two foam strips.

In such cases, the foam strips arranged next to each other in the functional direction will thus be permanently connected to each other, directly or indirectly, in the area of the bottom of the sealing tape.

For example, a continuous layer, preferably of a stiff material, can be arranged in the area of the bottom of the sealing tape. The foam strips can be permanently attached to the continuous layer. As a result, a solid connection is produced between the foam strips. When a stiff layer is used, the stiffness makes it possible to form sealing tapes of practically any desired width and increases the number of ways in which the sealing tape can be attached to the corresponding frame section of the structural part to be sealed. The continuous layer can also be provided in the form of single-sided or double-sided adhesive tape, which connects the two foam strips to each other.

Alternatively or in addition, the foam strips arranged next to each other in the functional direction can be designed as integral parts of each other in the area of the bottom of the sealing tape, so that they thus form a continuous connecting web there.

The method for equipping a sealing tape blank with a sheet-type strip comprises the following steps:

providing a sealing tape blank comprising a layer of flexible foam, and further comprising a top, a bottom, and two longitudinal sides, wherein a direction parallel to the top and bottom and transverse to the longitudinal sides defines a functional direction of the sealing tape blank;

introducing at least one incision or recess into the layer of flexible foam beginning from the top of the sealing tape blank, thus dividing the flexible foam into at least two interconnected adjacent sections;

folding open two adjacent sections of the flexible foam laterally outward and applying the sheet-type strip to at least certain areas of the folded-open adjacent sections; and

releasing the two adjacent sections of the flexible foam to allow the flexible foam to recover and thus to allow the sheet-type strip to form a section of the sheet-type strip arranged substantially in the shape of a U or V.

This method for equipping a sealing tape blank with a sheet-type strip is especially easy and low in cost and can be carried out in completely automated fashion.

The step of folding open two adjacent sections of the flexible foam is preferably carried out by means of at least one displacement roll. The displacement roll folds the two adjacent sections of the flexible foam toward the sides of the sealing tape blank, each section being folded toward the side of the blank to which it is closer, therefore preferably in a direction perpendicular to that of the incision. This means that the folding-open step can be carried out easily by machine.

With respect to the automation of the process, it is also advantageous for the sheet-type strip to be applied to the folded-open sections of the flexible foam by means of at least one applicator roll.

The step of applying the sheet-type strip to at least certain parts of the folded-open sections can be accomplished preferably immediately after the folding-open step, and it is especially preferable for these two steps to be carried out in combination. In this case, the at least one displacement roll and the at least one applicator roll would be arranged directly one behind the other, and the foam web would be conducted past the at least one displacement roll first and briefly thereafter past the at least one applicator roll. This ensures that, at the time of application, the flexible foam is still retaining its folded-open position. It is also possible, however, in cases where foams impregnated to provide an especially long delay of the recovery process are being used, to allow the at least one displacement roll and the at least one applicator roll to perform their functions at points relatively far apart.

### BRIEF DESCRIPTION OF THE DRAWINGS

Additional features and advantages of the present invention can be derived from the following description, which refers to the drawings.

FIG. 1 is a schematic perspective diagram of a first embodiment of the sealing tape according to the invention;

FIG. 2 is a schematic perspective diagram of an alternative embodiment of the sealing tape according to the invention;

FIG. 3 is a schematic perspective diagram of another alternative embodiment of the sealing tape according to the invention; and

FIGS. 4a-4c show in schematic fashion the sequence of steps of a preferred production method for the sealing tape according to the invention, in which a sealing tape blank is equipped with a sheet-type strip.

### DETAILED DESCRIPTION OF THE INVENTION

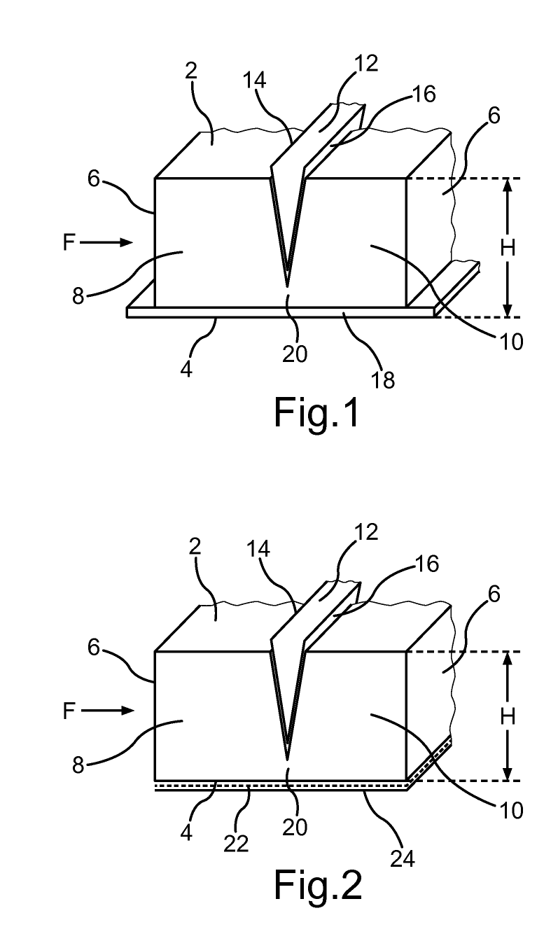

FIGS. 1-3 show three different schematic perspective diagrams of embodiments of the sealing tape according to the invention, the sealing tape being shown in its fully expanded state.

Each sealing tape comprises a top 2, a bottom 4, and two longitudinal sides 6, wherein a direction parallel to top 2 and bottom 4 and transverse to longitudinal sides 6 defines the functional direction (arrow F) of the sealing tape. It is in this functional direction F that the sealing tape is intended, after installation, to protect against driving rain and the passage of air as well as to limit, at least to a large degree, the diffusion of water vapor. Although this cannot be seen in FIGS. 1-3, the sealing tape extends farther in the longitudinal direction (i.e., in the plane of the drawing, indicated by the broken edges) than it does in the transverse direction, and it either exists in the form of strips or can be wound up into a roll or coil. A spiral roll in which the individual turns of the sealing tape rest directly on each other is especially preferred.

In the examples shown here, the sealing tape comprises two foam strips 8, 10 of a flexible foam capable of recovering its original shape after having been compressed. Two foam strips 8, 10 are arranged adjacent to each other in the functional direction F. It is also possible, however, to arrange more than two foam strips 8, 10 next to each other.

In the exemplary embodiments shown, foam strips 8, 10 of flexible foam have a substantially rectangular cross section, but any other suitable shape is also conceivable. Foam strips 8, 10 can be formed out of any suitable flexible open-cell or closed-cell foam such as foams of polyurethane or polyethylene, for example, and they can be impregnated to delay their recovery after compression. The weight by volume of these types of flexible foams is in the range of 20-200 kg/m³.

The material of first foam strip 8 can be different from that of second foam strip 10, so that, for example, the permeability to air of the sealing tape in the inner area is different from that in the outer areas or so that a vapor diffusion gradient is created. The width of foam strips 8, 10 can also be different as can their height or their degree and/or type of impregnation.

In practice, foam strips 8, 10 are usually precompressed in such a way that, when the pressure on them is released, they can expand preferably to a thickness which is approximately 5-10 times greater than that which they had in the precompressed state, although in many cases, to guarantee reliable contact with the building component opposite the profile element to be sealed, only about half of this capacity for expansion is actually used.

After the compressive force has been released by, for example, unwinding the sealing tape from the sealing tape roll, there is usually only enough time to install the sealing tape on the building component to be sealed and to place the component into the joint in the wall intended for it before the delayed expansion of foam strips 8, 10 makes the sealing tape too large to insert into the opening. Because current impregnation agents make it possible to delay the expansion of foam strips 8, 10 by several hours, however, this does not represent a significant limitation. When the sealing tape is in the form of strips, it is usually necessary to compress the strip before inserting it into the joint.

The sealing tape could basically also be attached to the structural component to be sealed before the component is transported to the construction site. In this case it would be necessary, however, to prevent the sealing tape from expanding by enclosing it in a wrapper (not shown). After installation of the component in the intended opening in the building, it would then be necessary merely to open the wrapper on site, whereupon foam strips 8, 10 expand outward and thus guarantee the sealing of the joint.

The sealing tape also comprises a sheet-type strip 12, which is arranged between two adjacent foam strips 8, 10 and bonded to them in such a way that it reduces or possibly even eliminates completely the permeability of the sealing tape to the diffusion of water vapor in the functional direction F. Sheet-type strip 12 comprises at least one section arranged substantially in the shape of a U or V, and the limbs 14, 16 of the U-shape or V-shape of sheet-type strip 12 extend toward top 2 of the sealing tape. In the completely expanded state of the sealing tape, limbs 14, 16 of sheet-type strip 12 (as shown in FIGS. 1-3) can project upward beyond top 2 of the sealing tape, or be flush with the top (not shown), or they can terminate inside the sealing tape (not shown) and thus not reach top 2 of the sealing tape. Limbs 14, 16, furthermore, do not have to be of equal length.

First limb 14 of the section of sheet-type strip 12 arranged in substantially the shape of a U or a V is bonded to at least certain areas of the side surface of first foam strip 8 facing second foam strip 10, and second limb 16 of the section arranged substantially in the shape of a U or V is bonded to at least certain areas of the side surface of second foam strip 10 facing first foam strip 8. Sheet-type strip 12 is preferably bonded to foam strips 8, 10 by the use of an adhesive, but a lamination process could also be considered.

Sheet-type strip 12 consists preferably of a plastic such as polyethylene, polypropylene, polyvinyl chloride, or rubber. The term “sheet-type”, however, is intended to cover all possible other materials such as foamed plastic of, for example, polyethylene, polypropylene, or cellular rubber. In addition, the material of sheet-type strip 12 can consist of paper such as waxed paper or of aluminum or of a mesh fabric suitable for the purpose indicated. For example, laminated sheets consisting of a plastic sheet laminated to a backing material (such as a nonwoven) or fabric-reinforced sheets are also usable. Combinations of these materials are also possible. Especially preferred are air-tight sheets which seal off the joint toward the inside of the room and also significantly reduce the permeability to vapor diffusion. The thickness of sheet-type strip 12 is between 10 μm and 5 mm, preferably between 50 μm and 2 mm.

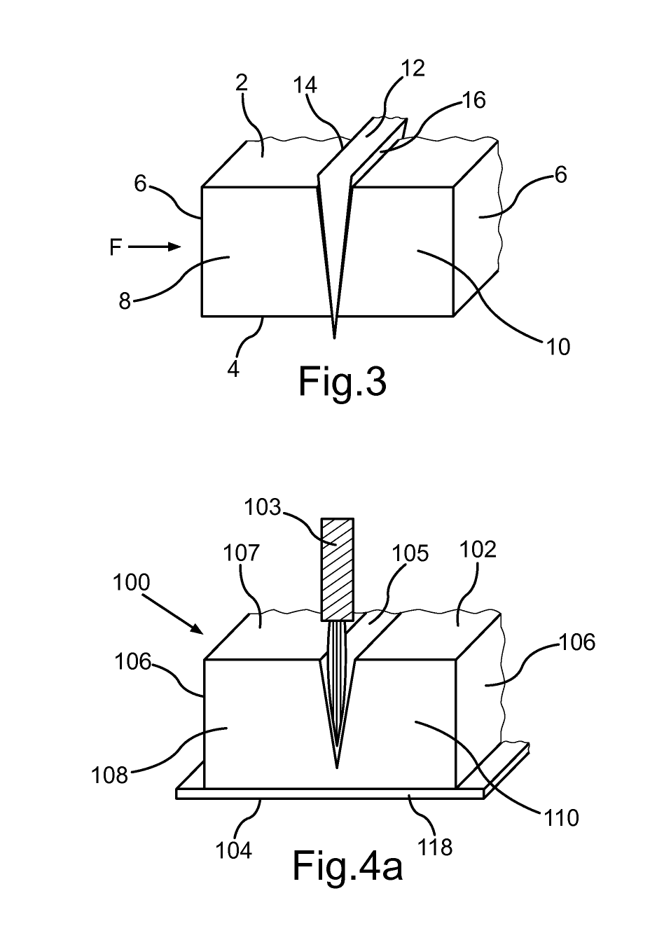

In the embodiments according to FIGS. 1 and 2, the crest or apex of the section of sheet-type strip 12 arranged substantially in the shape of a U or V is arranged inside the sealing tape. In FIG. 3, the crest or apex of the section of sheet-type strip 12 arranged substantially in the shape of a U or V extends downward beyond bottom 4 of the sealing tape. In principle, however, it is advantageous for the crest or apex of the section of sheet-type strip 12 arranged substantially in the shape of a U or V to be located within an area extending over a range of between 1 and 40%, preferably over a range of between 5 and 20%, of the height H of the sealing tape when the tape is in the fully expanded state.

When foam strips 8, 10 are in the expanded state, limbs 14, 16 of the section of sheet-type strip 12 arranged substantially in the shape of a U or V enclose an angle of preferably between 10° and 0°, and more preferably of between 3° and 0°. If the displacement cuts have been made cleanly during the production of the embodiments according to FIGS. 1 and 2 described further below in greater detail or if two separate foam strips 8, 10 are simply placed next to each other in an embodiment like that of FIG. 3, the angle between limbs 14, 16 will usually be 0°; that is, limbs 14, 16 will be resting directly against each other. In most cases, limbs 14, 16 of the section of sheet-type strip 12 arranged substantially in the shape of a U or V will therefore be substantially perpendicular to the functional direction F and parallel to side 6 of the sealing tape. In the drawings, the angle between limbs 14, 16 has been modified, i.e., made larger, for the sake of clarity. An even larger angle up to 45° between limbs 14, 16 is also conceivable if, during production, a corresponding recess is formed rather than a displacement cut extending into the flexible foam. A design in which two limbs 14, 16 are parallel to each other but arranged a certain distance apart is also conceivable. Many other designs are also possible.

In all cases, two foam strips 8, 10 are permanently connected to each other by sheet-type strip 12. In the embodiment according to FIG. 3, this strip also represents the only connection between two foam strips 8, 10.

In fact, however, it is preferable for first foam strip 8 and second foam strip 10 to be permanently connected to each other, directly or indirectly, in the area of the bottom 4 of the sealing tape.

For example, as shown in FIG. 1, a continuous layer 18, preferably of a stiff material or possibly even a continuous layer consisting of single-sided or double-sided adhesive tape, can be arranged in the area of bottom 4 of the sealing tape. In this case, it is advantageous for foam strips 8, 10 to be permanently connected to continuous layer 18 by a method such as lamination or by the use of a suitable adhesive. Continuous layer 18 can be flush with the sides of foam strips 8, 10, or it can project beyond them, as shown in FIG. 1, as a result of which sides 6 of the sealing tape are no longer completely flat. Layer 18 can be used advantageously, for example, to attach the sealing tape to the structural component to be sealed. When a stiff material is used, this attachment step can also be accomplished, for example, by wedging the sealing tape in the profile channels of the component. In addition, layer 18 of stiff material stabilizes the sealing tape in the width direction.

As the material of continuous layer 18, a foam which has a greater degree, preferably a much greater degree, of stiffness than foam strips 8, 10 is preferably provided. In addition, cardboard can also be considered, for example, but any other suitable stiff material such as a rigid plastic is also usable.

In the embodiment shown in FIG. 1, furthermore, two foam strips 8, 10 are designed so that they are connected integrally to each other in the area of bottom 4 of the sealing tape and thus form a continuous connecting web 20. It would also be possible to modify the embodiment of FIG. 1 by separating two foam strips 8, 10 completely from each other, with the result that there would be no continuous connecting web 20 present.

Conversely, it is advantageous in the case of the embodiment according to FIG. 2 for two foam strips 8, 10 to be connected integrally to each other and thus for continuous connecting web 20 between them to be formed, because as a result the sealing tape is held together more effectively as a compact unit.

In the embodiment of FIG. 2, furthermore, an adhesive layer 22, shown in broken line, is arranged on bottom 4 of the sealing tape. This adhesive layer is covered by a peel-off cover sheet 24. Adhesive layer 22 serves to attach the sealing tape by means of adhesive bonding to the structural component to be sealed after cover sheet 24 has been peeled off. The use of this adhesive layer 22 and of cover sheet 24 is also conceivable in the other embodiments discussed, but logically it is not applicable when double-sided adhesive tape is used as continuous layer 18. For the sake of illustrative clarity, adhesive layer 22, cover sheet 24, and foam strips 8, 10 are shown a short distance apart in FIG. 2. In reality they lie directly on top of each other The same is true for the section of sheet-type strip 12 arranged substantially in the shape of a U or V, which normally rests directly on or is bonded to the inner side walls of two foam strips 8, 10.

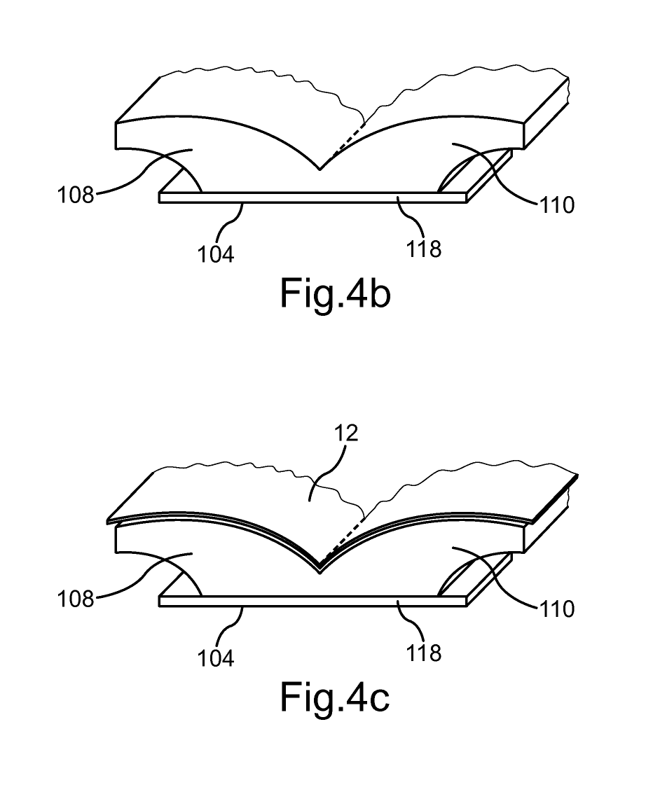

A preferred method for producing the sealing tape will now be described with reference to FIGS. 4a-4c and FIG. 1. A prefabricated sealing tape blank 100 is to be fitted out with sheet-type strip 12.

In FIG. 4a, the sealing tape blank 100 is provided which comprises a top 102, a bottom 104, and two sides 106 extending longitudinally, wherein a direction parallel to top 102 and bottom 104 and transverse to the sides 106 defines the functional direction F of sealing tape blank 100 and thus also of the later sealing tape. Sealing tape blank 100 also comprises a layer 107 of flexible foam. In the example shown here, sealing tape blank 100 also comprises a continuous layer 118 of stiff material. It is not necessary for this to be present, however.

Now at least one incision 105 or recess extending from top 102 of sealing tape blank 100 is introduced into layer 107 of flexible foam by means of, for example, a knife 103, as a result of which at least two interconnected sections 108, 110 of flexible foam are formed. As explained further above, incision 105 or recess preferably extends into the sealing tape as far as the preferred area for the location of the crest or apex of the section of sheet-type strip 12 arranged substantially in the shape of a U or V. A simple displacement cut is preferred, but it is also possible to remove material.

Then, as indicated schematically in FIG. 4b, two adjacent sections 108, 110 are folded open laterally. This is done preferably by means of at least one displacement roll (not shown). The at least one displacement roll is designed to push apart two sections 108, 110 of the flexible foam of sealing tape blank 100 being conducted past the roll and thus to give sealing tape blank 100 a wing-like shape with the flattest possible form.

A displacement roll of this type can have a special design (e.g., with a banana-like shape), or it can be specially arranged in such a way as to support the outward folding of sections 108, 110 of the flexible foam. The axis of the roll will usually be parallel to the functional direction F of sealing tape blank 100, but other arrangements with the axis at a slant to the functional direction, for example, are also conceivable. It is also possible to arrange several displacement rolls in a row.

The use of at least one pair of rolls which form a nip between them, through which sealing tape blank 100 is guided to fold open sections 108, 110 of flexible foam, is also conceivable. It is possible to imagine numerous other mechanisms which could be used to fold open the sections.

Then, as illustrated schematically in FIG. 4c, sheet-type strip 12 is applied to at least certain areas of folded-open sections 108, 110 of the flexible foam. Here again it is preferable to apply sheet-type strip 12 by means of at least one applicator roll (not shown), such as a so-called laminating roll. The shape of the sealing tape during the application of sheet-type strip 12 will therefore also be flatter and more level than that shown in the drawing.

The at least one applicator roll is arranged downstream from the at least one displacement roll. If the applicator roll is designed as a laminating roll, it will laminate sheet-type strip 12 to sections 108, 110 of the flexible foam. It can be advantageous to heat the laminating roll for this purpose. Sheet-type strip 12 can also be attached to the sections 108, 110 of the flexible foam by the use of an adhesive compound. In this case, too, it is advantageous for sealing tape blank 100 to be processed by means of a pressing roll, which presses sheet-type strip 12 onto the flexible foam.

The rotational axis of the applicator roll will usually be perpendicular to the direction in which sealing tape blank 100 is moving. Here again, it is also possible to use a pair of rolls which form a nip between them, through which the web of the sealing tape blank 100 passes.

It is especially preferable to carry out the step of applying sheet-type strip 12 to at least certain areas of folded-open sections 108, 110 of the flexible foam immediately after the folding-open step, and it is even more preferable to combine the two steps into one. For example, the at least one applicator roll can be arranged directly behind the at least one displacement roll, so that sections 108, 110 of the flexible foam are still in the laterally folded-open, flat-pressed state during the application of sheet-type strip 12. When impregnated flexible foams are used, this is not necessarily required, because, as a result of the impregnation, the flexible foam recovers only after a certain delay and thus sections 108, 110 of the flexible foam persist for a relatively long time in the laterally folded-open state.

Then two adjacent sections 108, 110 of the flexible foam are released, and the flexible foam is able to return to its original shape. This results in the formation of the substantially U-shaped or V-shaped section of sheet-type strip 12, wherein limbs 14, 16 of the section of sheet-type strip 12 arranged substantially in the shape of a U or V extend toward top 102 of sealing tape blank 100. The sealing tape in FIG. 1 represents the final state of the production example just described.

It should be clear that two adjacent sections 108, 110 of sealing tape blank 100 correspond to two foam strips 8, 10 of the finished sealing tape. Top 102, bottom 104, and sides 106 of sealing tape blank 100 similarly correspond to top 2, bottom 4, and longitudinal sides 6 of the finished sealing tape. To this extent, the description given previously for the sealing tape under reference to FIGS. 1-3 also applies to the arrangement and geometry of sealing tape blank 100 and of sheet-type strip 12 within sealing tape blank 100.

There are also other methods which can be used to produce the sealing tapes according to the invention.

Reference throughout this specification to “the embodiment,” “this embodiment,” “the previous embodiment,” “one embodiment,” “an embodiment,” “a preferred embodiment” “another preferred embodiment” “the example,” “this example,” “the previous example,” “one example,” “an example,” “a preferred example “another preferred example” or similar language means that a particular feature, structure, or characteristic described in connection with the embodiment or example is included in at least one embodiment or example of the present invention. Thus, appearances of the phrases “in the embodiment,” “in this embodiment,” “in the previous embodiment,” “in one embodiment,” “in an embodiment,” “in a preferred embodiment,” “in another preferred embodiment,” “in the example,” “in this example,” “in the previous example,” “in one example,” “in an example,” “in a preferred example,” “in another preferred example, and similar language throughout this specification may, but do not necessarily, all refer to the same embodiment.

Furthermore, the described features, advantages, and characteristics of the invention may be combined in any suitable manner in one or more embodiments or examples. One skilled in the relevant art will recognize that the invention may be practiced without one or more of the specific features or advantages of a particular embodiment or example. In other instances, additional features and advantages may be recognized in certain embodiments or examples that may not be present in all embodiments of the invention.

While the present invention has been described in connection with certain exemplary or specific embodiments or examples, it is to be understood that the invention is not limited to the disclosed embodiments or examples, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

What is claimed is:

1. A sealing tape for sealing a joint, comprising:
a top, a bottom, and two longitudinal sides, wherein a direction parallel to the top and bottom and transverse to the longitudinal sides defines a functional direction of the sealing tape;
at least one first foam strip and one second foam strip of a flexible foam capable of recovery after compression, the first and second foam strips arranged next to each other in the functional direction; and
a sheet-type strip serving to reduce a permeability of the sealing tape to diffusion of water vapor in the functional direction, the sheet-type strip arranged between the first foam strip and the second foam strip and comprising a section arranged substantially in the shape of a U or V,
wherein a first limb and a second limb of the section of the sheet-type strip arranged substantially in the shape of a U or V extend toward the top of the sealing tape.

2. The sealing tape of claim 1 wherein the first limb of the section of the sheet-type strip arranged substantially in the shape of a U or V is bonded to at least certain areas of a side surface of the first foam strip facing the second foam strip, and wherein the second limb of the section of the sheet-type strip arranged substantially in the shape of a U or V is bonded to at least certain areas of a side surface of the second foam strip facing the first foam strip.

3. The sealing tape of claim 1 wherein the sheet-type strip is laminated to the first and second foam strips or bonded to the first and second foam strips by means of an adhesive.

4. The sealing tape of claim 1 wherein a crest or apex of the section of the sheet-type strip arranged substantially in the shape of a U or V is arranged within the sealing tape.

5. The sealing tape of claim 1 wherein the first and second limbs of the section of the sheet-type strip arranged substantially in the shape of a U or V enclose an angle in the range of between 10° and 0°, when the sealing tape is in a fully expanded state.

6. The sealing tape of claim 5 wherein the first and second limbs enclose an angle in the range of between 3° and 0°, when the sealing tape is in the fully expanded state.

7. The sealing tape of claim 1 wherein the first and second limbs of the section of the sheet-type strip arranged substantially in the shape of a U or V are substantially perpendicular to the functional direction and parallel to the longitudinal sides of the sealing tape.

8. The sealing tape of claim 1 wherein a crest or apex of the section of the sheet-type strip arranged substantially in the shape of a U or V is located within an area extending over a range of between 1 and 40% of a height of the sealing tape when in a fully expanded state.

9. The sealing tape of claim 8 wherein the crest or apex of the section of the sheet-type strip arranged substantially in the shape of a U or V is located within an area extending over a range of between 5 and 20% of the height of the sealing tape when in the fully expanded state.

10. The sealing tape of claim 1 wherein the first foam strip and the second foam strip are permanently connected to each other directly or indirectly in an area of the bottom of the sealing tape.

11. The sealing tape of claim 10 wherein a continuous layer is arranged in the area of the bottom of the sealing tape.

12. The sealing tape of claim 11 wherein the continuous layer is made of a stiff material.

13. The sealing tape of claim 10 wherein the first and second foam strips are integrally connected to each other in the area of the bottom of the sealing tape and thus form a continuous connecting web.

14. A method of equipping a sealing tape blank with a sheet-type strip, comprising the following steps:
providing a sealing tape blank comprises a layer of flexible foam and further comprising a top, a bottom, and two longitudinal sides, wherein a direction parallel to the top and the bottom and transverse to the longitudinal sides defines a functional direction of the sealing tape blank;
introducing an incision or recess into the layer of flexible foam beginning from the top of the sealing tape blank and thus forming two interconnected adjacent sections of flexible foam;
folding open the two adjacent sections of the flexible foam and applying the sheet-type strip to at least certain areas of the folded-open adjacent sections; and
releasing the two adjacent sections of the flexible foam to allow the flexible foam to recover and thus to allow the sheet-type strip to form a section of the sheet-type strip arranged substantially in the shape of a U or V.

15. The method according to claim 14 wherein the step of folding open the two adjacent sections of the flexible foam is carried out by at least one displacement roll.

16. The method of claim 15 wherein the sheet-type strip is applied to the folded-open adjacent sections of the flexible foam by means of at least one applicator roll.

17. The method of claim 16 wherein the step of applying the sheet-type strip to at least certain areas of the folded-open adjacent sections is carried out immediately after the folding open step.

18. The method of claim 17 wherein the step of applying the sheet-type strip to at least certain areas of the folded-open adjacent sections is carried out immediately after the folding open step in a step which combines the operations of folding open adjacent sections and applying the sheet-type strip.
